(19) United States
(12) Patent Application Publication
(10) Pub. No.: US 2012/0277886 A1
(43) Pub. Date: Nov. 1, 2012

(54) METHOD FOR SETTING A CONTROL DEVICE

(76) Inventors: Markus Bossler, Fellbach (DE); Maximilian Reger, Stuttgart (DE); Juergen Berkemer, Vaihingen/Enz (DE); Bodo Sauer, Freiberg A.N. (DE)

(21) Appl. No.: 13/510,039

(22) PCT Filed: Dec. 13, 2010
(86) PCT No.: PCT/EP2010/069461

§ 371 Date: Jul. 23, 2012

(30) Foreign Application Priority Data
Dec. 16, 2009 (DE) 10 2009 054 780.0

(51) Int. Cl. G05B 13/02

(52) U.S. Cl. 700/28

(57) ABSTRACT

A method for adjusting a control unit, in which a calibration of a control unit parameter constituting a bypass is carried out, a control unit parameter, embodied as a calibration parameter, of the software of the control unit being calibrated, and at least one function, with which at least one signal is taken into account, being written onto an address region of the control unit parameter. An assemblage for adjusting a control unit is also described.

### FIELD OF THE INVENTION

The present invention relates to a method and an assemblage for adjusting a control device.

### BACKGROUND INFORMATION

The software for the engine control system of a vehicle encompasses a plurality of functions which are embodied to take over, by way of actuators and sensors, monitoring or open- and/or closed-loop control of the engine and of vehicle reactions. Functions used for this are created during function development, the parameters, characteristic curves, and/or characteristics diagrams required therefor being then designed in project-specific fashion in an application.

So-called “application tools” such as, for example, ASCET or INCA of the ETAS company, are used in function development. Special software adaptations are in some cases necessary for these application tools so they can be used to affect control unit calculations. The application tools are also provided for performing adjustments to control unit parameters or labels, and thus, e.g., to characteristics diagrams, characteristic curves, fixed values, etc.; and for measuring control unit signals.

Also available in the field of control unit development for vehicle drive systems are multiple capabilities for fast testing of newly developed or adapted functionalities in the software/control unit complex without needing to generate, and therefore produce, an entire new software package for every change in functionality.

This is achieved, inter alia, with so-called bypasses in the software of a control unit, which allow a function, calculated in parallel, to be latched into the structure of the software via interfaces, and thus to be made functionally active. A distinction is made here between internal and external bypasses. Special modifications to the software of the control unit are needed for each type of bypass.

### SUMMARY

The present invention makes available, inter alia, application tools for functional expansion of label bypasses or bypasses for control unit parameters, as well as the capabilities resulting therefrom.

In an example embodiment of the method, an adjustment of a control unit is carried out using a typically external bypass, by label calibration or calibration of a control unit parameter, the possibility existing of, inter alia, access to the control parameters.

In an example embodiment, for this purpose a bypass function is used in the environment of the application tool and makes it possible, inter alia, to stimulate or impress, by way of a function of the usually external bypass as a result of label calibration or calibration of the control unit parameter, at least one measured, calculated, and/or simulated signal by fast calibration of a software-internal calibration value, and thereby to make the at least one signal available in the software calculation. Signals can thereby be injected into a control unit without software modification.

This yields, among other things, a reduction in multiple individual tools in a tool concept, with the result that a license reduction can be achieved. In addition, external signals can be injected into the control unit and/or signal excitations can be injected into a system that encompasses the software and/or the control unit. The possibility also exists of carrying out function tests and/or function modifications without software adaptation. A user can thus be integrated into the development process of the software and/or of the control unit. The software development process can be shortened.

In a further example embodiment of the present invention, functions calculated in parallel are, with the method for implementing the bypass in accordance with the present invention, latched in via the functions' calibration variables or labels, or control unit parameters, already present in the software, and not via newly defined and generated interfaces. The output or outputs of a function (typically calculated in parallel) can thus be written to the address region of the calibration variables in the control unit software so quickly that the output or outputs of the function calculated in parallel become effective, via the calibration variable, in online and thus in-service fashion with no need for computer resources internal to the control unit, or thus for a processor and/or memory of the control unit.

This example embodiment creates a broad range of utilization capabilities, flexibility in use, fast functional testing, and thus savings of time and cost.

The method for making the bypass available is usually dependent on the functional structure. In most cases an external bypass is therefore made available with no need to modify the software. Modifications that are otherwise necessary for a bypass no longer need to be defined and implemented.

The assemblage according to the present invention is embodied for carrying out all steps of the method presented. Individual steps of this method can also be carried out by individual components of the assemblage. Functions of the assemblage, or functions of individual components of the assemblage, can furthermore be implemented as steps of the method. It is moreover possible for steps of the method to be realized as functions of individual components of the assemblage or of the entire assemblage.

Further advantages and configurations of the present invention are clear from the description below and the figures.

It is understood that the features mentioned above and those yet to be explained below can be used not only in the respective combination indicated, but also in other combinations or in isolation, without leaving the context of the present invention.

### BRIEF DESCRIPTION OF THE DRAWINGS

FIG. 1 is a diagram of a first example embodiment of a method according to the present invention.

FIG. 2 schematically depicts a control unit and a computer in the context of a second embodiment of a method according to the present invention.

FIG. 3 schematically depicts a control unit and a computer in the context of a third embodiment of a method according to the present invention.

FIG. 4 schematically depicts a detail of a fourth embodiment of a method according to the present invention.

FIG. 5 schematically depicts a detail of a fifth embodiment of a method according to the present invention.

FIG. 6 schematically depicts a detail of a sixth embodiment of a method according to the present invention.

### DETAILED DESCRIPTION OF EXAMPLE EMBODIMENTS

The present invention is depicted schematically in the figures on the basis of example embodiments, and will be described in detail below with reference to the figures.

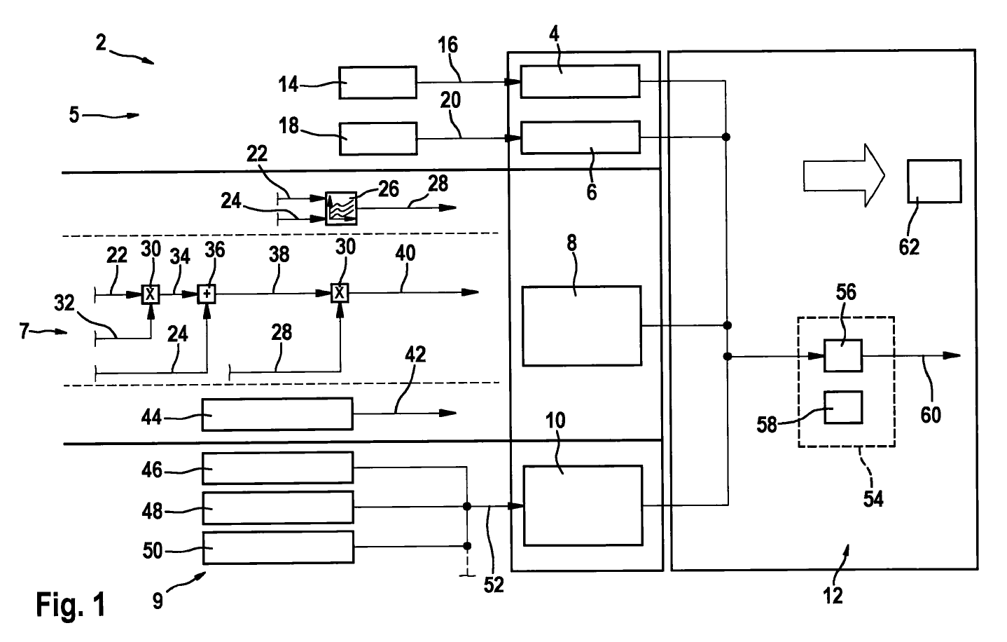

The diagram of FIG. 1 shows, in a left portion, three methods for a signal supplying system 2, namely for signal sensing 5, signal calculation 7, and signal simulation 9. A center portion 4 of FIG. 1 schematically depicts hardware units 4, 6 as well as software units 8, 10. A third region of FIG. 1, reproduced on the right, shows an example for supplying a bypass function 12 or bypass functionality in an application tool, in this case INCA of the ETAS company.

In the method for signal sensing 5, a first sensed signal 16 (here a voltage) is supplied by a first sensor 14, and a signal 20 (here also a voltage) is supplied by a second sensor 18. First sensed signal 16 is furthermore transferred to first hardware unit 4, which is embodied to implement a thermo scan or a temperature sensing operation. Second sensed signal 20 is transferred to second hardware unit 6 in order to sense a voltage (AD scan).

In the context of signal calculation 7, for example, in a first instance a calculation 26 is carried out for a first signal 22 and a second signal 24, and a first calculated signal 28 is thus supplied. In a second instance of a signal calculation 7, first signal 22 is multiplied by a constant 32 by way of a multiplication 30. In a subsequent addition 36, second signal 24 is added to a product 34 resulting from multiplication 30. A sum 38 resulting therefrom is further multiplied by first calculated signal 28 in a multiplication 30, and a second calculated signal 40 is supplied as a result thereof. In a third instance of a signal calculation 7, a third calculated signal 42 is supplied by a signal generator 44. The three aforesaid calculated signals 28, 40, 42 are transferred to first software unit 8.

In the context of signal simulation 9, a simulated signal 52 is generated using a first model 46 for implementing a software hook (executed here using software suitable therefor), a physical model 48, and a data-based model 50, and is supplied to second software unit 10, which in this case is operated with the Integrio Hex A2 software of the ETAS company.

In the context of an INCA experiment, the supplied signals 16, 20, 22, 24, 28, 40, 42, 52 are delivered, in order to implement bypass function 12, from the aforesaid units 4, 6, 8, 10 to a label bypass 54 or to a bypass for a control unit parameter. This label bypass 54 encompasses a first function 56 as well as a second function that is embodied to implement a complete calibration method. Signals 16, 20, 22, 24, 28, 40, 42, 52 are also, after implementation of label bypass 54, delivered to a label and thus to a calibration parameter 60 or to the control unit parameter. Provision is moreover made, in supplementary fashion, for signals 16, 20, 22, 24, 28, 40, 42, 52, to be transferred to a control unit 62.

In this first embodiment of the method shown in FIG. 1, bypass function 12 that, by way of the various hardware and software devices or units 4, 6, 8, 10, injects the available signals 16, 20, 22, 24, 28, 40, 42, 52 into the software structure, is integrated into the application tool, e.g., INCA. Injection into the software is implemented via label bypass 54, usually via at least one of the aforesaid functions 56, 58, by fast calibration of the address region of a selected calibration variable or of a selected control unit parameter in the software. The bypass function 12 in accordance with the present invention in the application tool thus offers the possibility of stimulating a sensed, calculated, and/or simulated signal 16, 20, 28, 40, 42, 52 onto a selected calibration variable. The output of the calibration variable, for example a RAM cell in the control unit software, then corresponds to the profile of signal 16, 20, 28, 40, 42, 52 and is thus incorporated into further calculation of the functions of the control unit.

Hardware (HW) units 4, 6 or devices are measurement and/or calibration modules for data sensing and data calibration. Data in this context can be control unit variables or external sensor variables that are sensed via these hardware units 4, 6 and are made available in the application tool by selecting the units 4, 6 and signal 16, 20 of bypass function 12.

Software (SW) units 8, 10 are in this case those instruments with which the outputs of the calculations and simulations are supplied as signals 28, 40, 42, 52 in the application tool and thus made available to bypass function 12, for example calculated signals in an INCA “calcDevice,” models from Integrio, etc.

A variety of signals 16, 20, 22, 24, 28, 40, 42, 52 are sensed and/or calculated in the context of the present invention. Measured signals 16, 20 are sensed via a hardware unit 4, 6. Measured signals 16, 20 encompass control unit variables or data from sensors that are located outside the control unit. By way of the concept, external sensors are made available for calculations in the control unit via bypass function 12 in INCA.

Using calculated signals 28, 40, 42, it is possible to define arithmetic calculation instructions that, by way of this embodiment of bypass function 12 in the application tool, are likewise available for calculations in the control unit. This yields the possibility of function development in the application tool. A further possibility that exists is that of realizing, by way of calculated signals 28, 40, 42, a signal generator with which the system can be stimulated, for example, for control-engineering purposes.

If models are incorporated as software units 8, 10 into the application tool, for example Integrio as an environment for various model types, for example model 46 for software hooks as well as physical and data-based models 48, 50, these can likewise, by way of the concept of bypass function 12, be injected into the calculations in the control unit, creating the possibility of applying function developments by way of the application tool. The inputs of models 46, 48, 50 can also be provided with measured signals 16, 20 from hardware units 4, 6.

Sensed, calculated, and simulated signals 16, 20, 22, 24, 28, 40, 42, 52 are made available in the application tool via hardware and software units 4, 6, 8, 10. These signals 16, 20, 22, 24, 28, 40, 42, 52 can be stimulated and/or impressed onto calibration variables by way of bypass functionality or bypass function 12. Externally sensed signals 16, 20, 22, 24, 28, 40, 42, 52, calculations from signals 16, 20, 22, 24, 28, 40, 42, 52, and simulation results thereby become effective in the control unit.

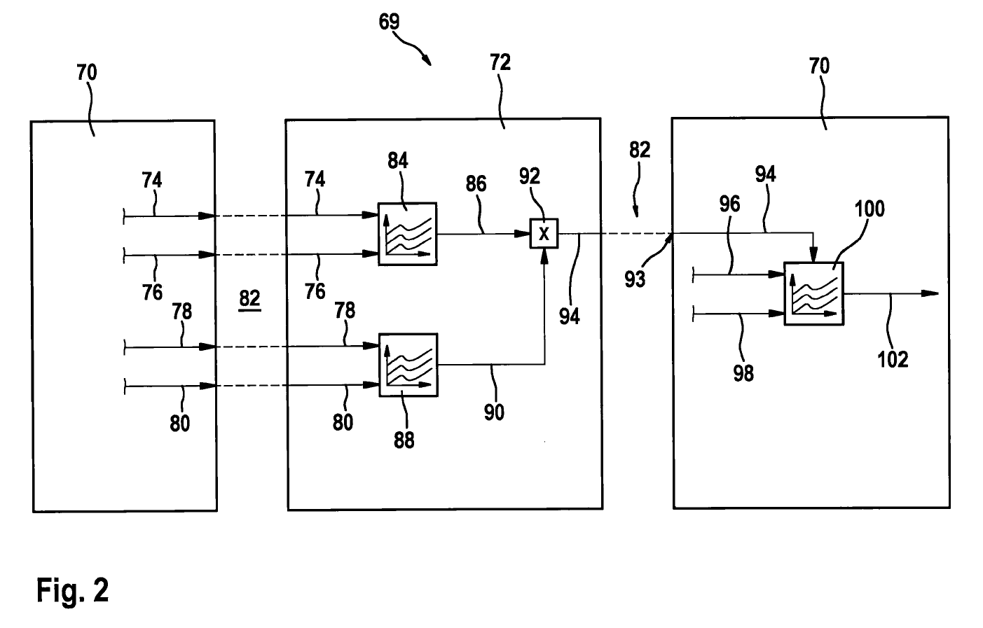

FIG. 2 shows a second example embodiment of a method according to the present invention that relates to a function test of a characteristics diagram expansion. FIG. 2 schematically depicts an embodiment of a control unit 70 and an embodiment of an assemblage 69 according to the present invention that here encompasses a computer 69 connected to control unit 70.

In detail, FIG. 2 shows on the left a schematic depiction an embodiment of a control unit 70 in the context of a first step of a method, at the center a schematic depiction of a computer 72 or PC in the context of a second step of the method, and on the right once again control unit 70 in the context of a third step of the method depicted here.

In the first step, a first signal 74 (n), a second signal 76 (q), a third signal 78 (t), and a fourth signal 80 (l) are supplied by control unit 70 on the basis of measurements for measured variables. With implementation of a bypass 82, the aforesaid signals 74, 76, 78, 80 are transmitted to computer 72. In computer 72, a first intermediate signal 86 is supplied, in the context of a first calculation 84, from first and second signal 74, 76. In the context of a second calculation 88, a second intermediate signal 90 is supplied from third and fourth signal 78, 80. In the context of a subsequent calculation that is a multiplication 92, a first output signal 94 is supplied from the two intermediate signals 86, 90. In addition, a search is made for a calibration variable 93, or a control unit parameter or label, which already exists in the software of control unit 70 and into whose address region the output signal 94 is written via bypass 82 by calibrating calibration variable 93, and is thus delivered to control unit 70 in a time interval of less than one millisecond. In control unit 70, first output signal 94 as well as two further signals 96, 98 are subjected to a further calculation 100, and a second output signal 102 is thereby calculated.

In the second embodiment of the present invention, a localization of the capability for affecting the software of control unit 70 is therefore performed. A search is then made, in the structure of the software, firstly for calibration variable 93 that is suitable as an interface for utilization. Undesired influences of further calibration variables in terms of functionality can in many cases be deactivated by inputting neutral data for fixed values, characteristic curves, and characteristics diagrams.

Control unit 70 furnishes, in predefined calculation steps, measured variables that can be queried via a data connection. At the same time, the address region of a calibration variable 93 can be overwritten.

With these two mechanisms (localization and activation), and thanks to the quickness of the intervention, the mode of operation of the bypass method is realized. At least one of these mechanisms creates the possibility of picking off from the software of control unit 70 all the signals 74, 76, 78, 80 necessary for a function calculated in parallel, calculating the function using signals 74, 76, 78, 80, and writing the result of the calculation onto the address region of the chosen calibration variable 93. The result is thus available online in the software of control unit 70.

It is usually possible within a period of 1 ms to sense, as signals 74, 76, 78, 80, the measured data outputted from control unit 70, and to write to the address regions of entire characteristics diagrams in less than 1 ms. This capability is offered, for example, by the fast control unit access called “Fast Ecu Access” of the ETAS company. The range of applicability of the bypass method becomes wider with even faster access capabilities.

FIG. 2 thus depicts a function test of a simple characteristics diagram expansion. Here a characteristics diagram of the function of the control unit is replaced by a logical combination of two characteristics diagrams that are calculated in parallel on computer 72. The characteristics diagram combination is calculated on computer 72 using current measured data of the software of control unit 70 as inputs of the characteristics diagrams. The result of the calculation is then written onto the entire address region of the values of the characteristics diagram of the software of control unit 70. Regardless of the original inputs, the characteristics diagram now encompasses only the result of the calculation from computer 72 as an output, since the entire address region has had that written to it. The calculations of computer 72 consequently become effective in control unit 70.

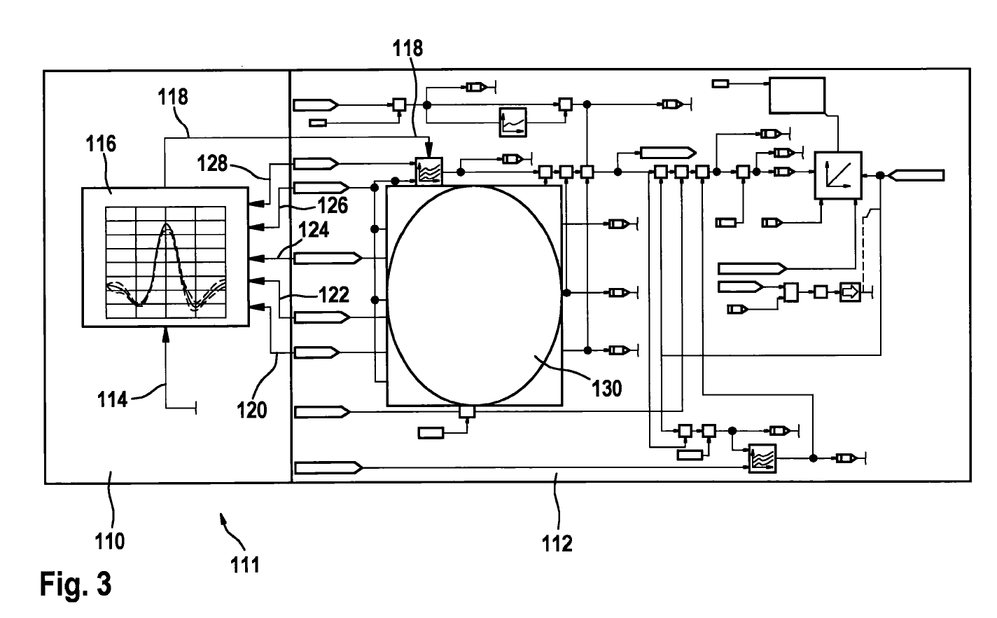

FIG. 3 illustrates a third embodiment of a method according to the present invention for implementing a function test of a data model. FIG. 3 schematically depicts a computer 110 for carrying out a mathematical program. This computer 110 is embodied as a component of a configuration of an assemblage 111 according to the present invention. Also depicted in FIG. 3 are details of a signal processing operation in a control unit 112 that is connected to computer 110. The signal processing operation relates to a sensing of signals, and to a provision of further signals by the performance of calculation operations.

Signals are delivered to mathematical program 110 via an input 114, and are modeled with an ASC data model 116. At least one modeled signal supplied in this context is delivered via a bypass 118 to control unit 112. In the present embodiment of the method, calculations are carried out inside control unit 112 for various signals. From these signals, output signals 120, 122, 124, 126, 128 are supplied and are delivered to ASC data model 116 of a second calculation.

Provision is further made that a deactivation 130 is performed inside control unit 112 by inputting neutral data to characteristics diagrams.

FIG. 3 also depicts the function test of a model, typically of a data model. The model is calculated in parallel on a computer 110. The inputs of the model are current measured data from control unit 112. The calculated output of the model is written again onto the entire address region of the values of the chosen characteristics diagram, and the model thus becomes effective in control unit 112. Further influences on the function structure can be deactivated here by inputting neutral data for further calibration variables.

The bypass method described makes it possible, by way of an application tool or a tool kit, to latch in a function, calculated in parallel, via a bypass 118 without needed to modify the control unit software.

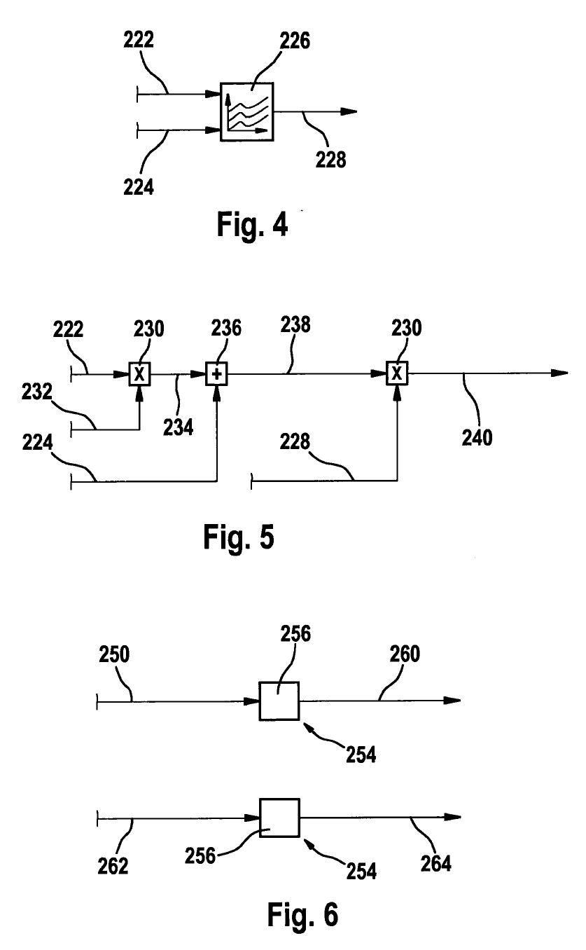

A detail of a fourth example embodiment of the method according to the present invention is depicted schematically in FIG. 4. Here a first signal 222 and a second signal 224, both supplied by a control unit, are delivered to a virtual characteristics diagram 226. From virtual characteristics diagram 226, a modified calculated signal 228 is generated and/or prepared.

Calculated signals 228 can thus also be generated, within an application tool, via virtual characteristics diagrams 226 whose inputs are freely configurable. Virtual characteristics diagram 226 can be generated within the application tool and is not a characteristics diagram 226 of the software structure. By way of the measured inputs and by interpolation of the entered data of characteristics diagram 226, it generates the newly calculated signal 228 as an output of virtual characteristics diagram 226.

In the example embodiment described with FIG. 4, similarly to the example embodiment described with reference to FIG. 1, a signal calculation 7 is carried out, a calculation being accomplished using virtual characteristics diagram 226. This calculated signal 228 can be logically combined with other ECU variables and with mathematical calculations that are supplied by the application tool. These combinations of the calculated signal 228 yield a function structure as provided in the fifth embodiment, depicted schematically in FIG. 5, of the method according to the present invention.

Here, a first signal 222 is multiplied by a constant 232 by way of a multiplication 230. In a subsequent addition 236, a second signal 224 is added to a product 234 resulting from multiplication 230. A sum 238 resulting therefrom is further multiplied, in multiplication 230, by first signal 228 calculated via virtual characteristics diagram 226, and as a result thereof a second calculated signal 240 is supplied as an output.

A plurality of mathematical calculations are provided in application tools. To allow function structures comparable to those in the software of a control unit to be reproduced therewith, virtual characteristics diagrams 226 or virtual characteristic curves are provided in an embodiment of the invention.

Using the function structures that are created, and the calculated signals 226, 228, the function structures of the software of the control unit can be computed, compared, and thus checked. The quality of the software can be improved with these checking capabilities.

As shown schematically in FIG. 6, in the sixth embodiment of the method a signal 250 of a control unit (ECU) is delivered to a function 256 within a label bypass 254. The function is embodied to convert a complete calibration method. Signal 250 is delivered from function 256 of label bypass 254 to a calibration variable 260 and thus, typically, to a control unit parameter. A calculated signal 262 that is calculated via a virtual characteristics diagram is correspondingly delivered to function 256 of label bypass 254. This calculated signal 262, emerging from function 256, is likewise delivered to a calibration variable 264.

Existing functions 256 can be tested by using label bypass 254. In supplementary fashion, new function structures can also be made effective and tested in the software, with an external bypass, by fast label calibration.

The signals effective via stimulation of label bypass 254 can be direct signals of the control unit, calculated signals, or signals read in externally (e.g. from sensors) via input/output (I/O) cards, which signals then become available in the software calculation.

The present invention makes it possible, among other things, to permit simple, fast function development using ordinary application tools, without modifying the software structure. The outlay for testing simple function changes can thus be reduced. A further possibility exists for easily checking existing software structures. A user is given the ability to test necessary function adaptations prior to a software modification, and to make available the results of the investigation of the function development.

For example, if a user on a test drive of a vehicle under development identifies an additional correlation in an existing function, the consequence of this can be that he cannot carry out his work package and cannot test the presumed correlation. It usually takes a long time for a software program having a corresponding adaptation to be become available.

The present invention creates the capability, for the environment of the application tool, of impressing a signal via an external bypass, by label calibration of measured or calculated signals of the control unit software, by fast calibration of a software-internal calibration value, and thus making it available in the software calculation system. In combination with the capability of generating calculated signal variables for many application tools, new calculations can be carried out and they can be made available in the software by stimulating suitable labels. In an example embodiment of the present invention, calculated signal variables are generated by way of virtual characteristics diagrams, so that simple function structures can be reproduced or tested, or new ones created. Checking of function structures can also be carried out. Fast function tests and/or function expansions are also possible without requiring modifications to the software or additional tools.

1-10. (canceled)

11. A method for adjusting a control unit, comprising:
calibrating a control unit parameter, the control unit parameter being embodied as a calibration parameter of software of the control unit, the calibration constituting a bypass; and
writing at least one function, with which at least one signal is taken into account, onto an address region of the control unit parameter.

12. The method as recited in claim 11, wherein the at least one function includes at least one of a measured signal, a calculated signal, and a simulated signal.

13. The method as recited in claim 11, wherein the at least one function is dependent on at least one of a measured, a calculated, and a simulated signal.

14. The method as recited in claim 11, further comprising:
simulating, via use of an application tool, at least one signal supplied by calibration of a software-internal calibration variable onto the calibration variable, and injecting the at least one signal into the control unit.

15. The method as recited in claim 14, wherein a bypass function is integrated into the application tool, the at least one function with which the at least one signal is taken into account being injected into a structure of the software.

16. The method as recited in claim 14, wherein the at least one signal is supplied to the application tool via at least one of a hardware unit and a software unit.

17. The method as recited in claim 11, further comprising:
searching for an already existing calibration variable; and
activating a bypass for the already existing calibration variable.

18. The method as recited in claim 11, wherein the control unit is connected to a computer, the control unit and the computer exchanging signals with one another.

19. The method as recited in claim 11, wherein the at least one signal is generated via a virtual characteristics diagram.

20. The method as recited in claim 19, further comprising:
calculating at least one second signal from the at least one signal using the virtual characteristics diagram.

21. An assembly for adjusting a control unit, comprising:
at least one computer configured to calibrate a control unit parameter, embodied as a calibration parameter, of the software of the control unit, the calibration constituting a bypass; and
writing at least one function, with which at least one signal is taken into account, onto an address region of the control unit parameter.
